(19) United States
(12) Patent Application Publication
(10) Pub. No.: US 2012/0207884 A1
(43) Pub. Date: Aug. 16, 2012

(54) EDIBLE GLUES AND APPLICATORS FOR SAME

(75) Inventors: Amy Stevens Adams, Falmouth, MA (US); John R. Sedivy, Falmouth, MA (US); Victor J. Temple, Falmouth, MA (US)

(73) Assignee: Get Sassie, Inc., Falmouth, MA (US)

(21) Appl. No.: 13/362,680

(22) Filed: Jan. 31, 2012

Related U.S. Application Data
(60) Provisional application No. 61/442,584, filed on Feb. 14, 2011.

(51) Int. Cl. A23B 7/148; B65D 81/32

(52) U.S. Cl. 426/106; 220/200; 432/247; 426/115; 426/531

(57) ABSTRACT

Described herein are edible glues and customized applicators for delivering the same.

### RELATED APPLICATIONS

This application claims the benefit of priority to U.S. Provisional Patent Application Ser. No. 61/442,584, filed on Feb. 14, 2011; which is hereby incorporated by reference in its entirety.

### BACKGROUND OF THE INVENTION

A common method for attaching an edible design element to a fondant covered wedding cake is by means of Royal Icing, a pure white icing that dries to a smooth, hard, matte finish. However, Royal Icing dries thick and takes a relatively long time to dry (ranging from several hours to overnight). In addition, Royal Icing can become wet in humid conditions, thereby losing its adhesive grip. In addition, the white color can clash with certain designs. The Royal Icing approach also requires prior preparation and airtight storage prior to use.

Another, less common method of attaching edible design elements to fondant covered wedding cakes is by use of a piping gel, a clear and sticky commercial product that has limited adhesive power, and only works for attaching lightweight elements.

Design elements can also be attached to a fondant base using water and a small brush. When combined with fondant, water works well as an adhesive, because it reconstitutes the fondant it is applied to and makes it sticky. The fondant elements may be attached to one another and as the water dries it creates a strong bond. However, this method is problematic for several reasons. First, it is inflexible: water can drip on the fondant which will stain it. It is also unreliable: water as an adhesive is not as reliable in humid conditions and when attaching heavy design elements. It is also inconvenient: wedding cakes are often assembled on location, and water may not be easily accessible.

Melted sugar can also be used to attach edible design elements, as well as to make candy (e.g., lollipops and hard candies) and sugar sculptures. However, current methods for melting sugar are time-consuming, requiring at least about one hour of uninterrupted time. In addition, melting sugar to obtain an appropriate color and consistency is a complex project. For example, if sugar is stirred while in the cooking stages it can crystalize. If sugar is cooked above temperatures of approximately 275° F. or higher, it turns amber in color. For true hard candy or to be used as decoration, sugar must be cooked to the hard crack stage which is in the range of 300 to 310° F. At this temperature, sugar will be yellow and discolor the final product. In addition, food coloring can only be effectively added to the finished sugar between temperatures of about 305 and 310° F., so as not to disrupt the cooking process. Achieving the desired color can be challenging since the sugar already exhibits an amber color. Further, the process requires precise handling. Melted sugar must remain hot in order to retain liquid consistency, but can crystalize if the temperature is too hot or harden quickly if cooled. Finally, current processes for melting sugar are accompanied by a significant risk of burn. Sugar retains a hotter temperature than anything else in a kitchen and melted sugar can splatter or splash out of a container during transfers.

New methods and compositions-of-matter for attaching an edible design element to a fondant covered cake are needed.

### SUMMARY OF THE INVENTION

In one aspect, the invention features edible glues, which are useful for attaching edible design elements (e.g. candy, edible ribbons, pastillage ornaments, fondant ornaments, sugar decorations, gum paste ornaments, chocolate decorations, gingerbread houses, Royal Icing decorations) to an item, for example, a culinary item, such as fondant covered cake, flooded cookie, gum paste sculpture, gingerbread house, croquembouche, sugar sculpture or chocolate sculpture. The invention is also useful for attaching inedible design elements (e.g., a cake base, fabric ribbons, fresh flowers, glass or plastic gemstones, cake toppers or paper decorations) to an edible culinary item (e.g. fondant covered cake, flooded cookie, gum paste sculpture, gingerbread house, croquembouche, sugar sculpture or chocolate sculpture).

In another aspect, the invention features edible glues in combination with an applicator. In certain embodiments, the glue is formulated into a semi-solid formulation and the applicator is a semi solid dispensing apparatus.

In another embodiment, the edible glue is a liquid or sap and the applicator is a dispensing apparatus, such as a squeeze bottle.

In another embodiment, the edible glue is a liquid or sap and the applicator is a dispensing apparatus, such as an aerosol or pump spray bottle, or aerating device.

In another embodiment, the fast drying edible glue is a liquid or sap and the applicator is a dispensing apparatus such as a droplet squeeze bottle or a glass vial with a brush contained within a cap (e.g., similar to a nail polish bottle).

In another embodiment, the edible glue possesses taste (e.g., cherry, cinnamon, mint, vanilla, grape, lemon, lime, coconut, strawberry, melon, root beer, maple, chocolate, orange, watermelon, butterscotch, caramel, raspberry, cranberry, apricot, and marshmallow).

In another embodiment, the edible glue possesses scent (e.g., cherry, cinnamon, mint, vanilla, grape, lemon, lime, coconut, strawberry, melon, root beer, maple, chocolate, orange, watermelon, butterscotch, caramel, raspberry, cranberry, apricot, marshmallow, lavender, rose, gingerbread, spruce, baked apple pie, sugar cookies, hot cider, and vanilla butter cream).

In yet a further embodiment, the edible glue is a solid and the applicator is a device, which can melt the solid into a semi-solid or liquid. In certain embodiments, the device is pre-set at a temperature, which is ideal for melting the particular solid glue. In another embodiment, the device includes an adjustable temperature control, which would allow the user to specify whether the solid glue is to be melted into a thicker or less thick consistency. In certain embodiments, the device is shaped as a gun, which contains a cavity for a glue stick. This embodiment minimizes the potential for the user to be burned by melted glue. In other embodiments, the gun contains a no-drip nozzle and/or a child safety lock, so that the user can pause while using the device. The gun may be powered by a variety of power sources, including a battery.

In other embodiments are featured methods of attaching design elements to items using the above described edible glues.

The novel compositions and devices described herein are easy to use. In addition, the glues dry quickly to produce an invisible and strong edible bond between a design element and other item.

Further features and advantages of the compositions and methods described herein will be apparent from the following Detailed Description and Claims.

### BRIEF DESCRIPTION OF THE DRAWINGS

FIG. 1 is an illustration of a fondant-covered wedding cake with edible attachments.

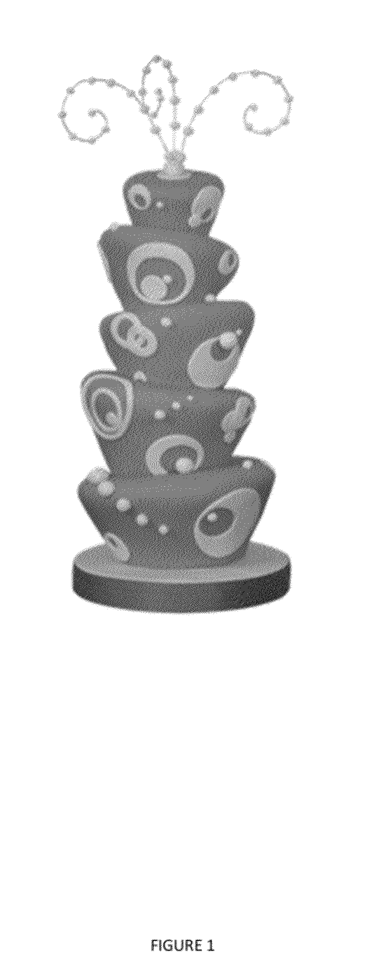

FIG. 2 is an illustration of flooded cookies.

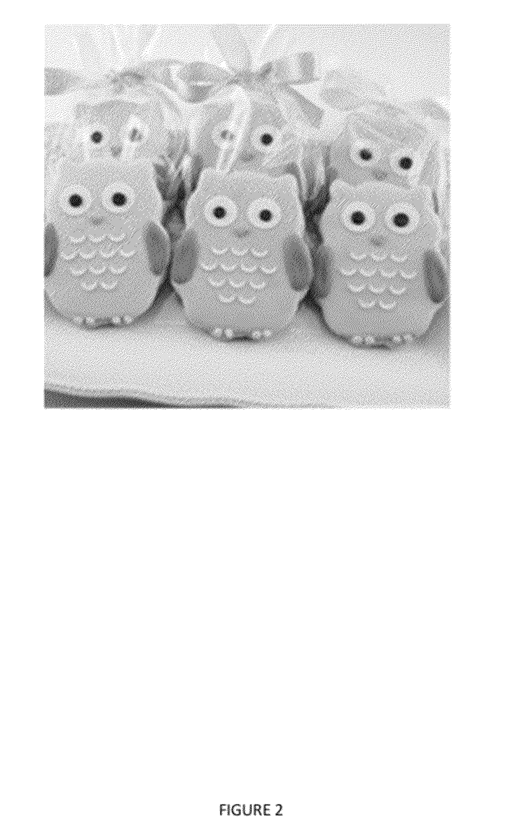

FIG. 3 is an illustration of a gum paste shoe sculpture.

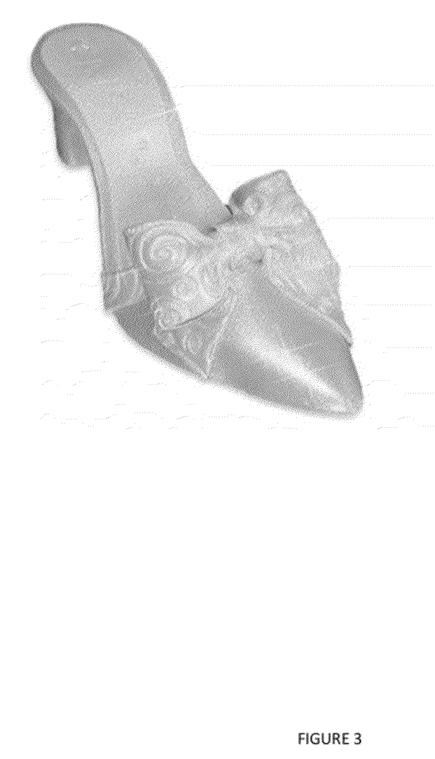

FIG. 4 is an in illustration of a package of three edible glue sticks.

FIG. 5 is an illustration of an edible glue sap contained in a squeeze bottle.

FIG. 6 is an illustration of an edible glue mist.

FIG. 7 is an illustration of an edible quick dry glue.

FIG. 8 is an illustration of an edible glue gun.

FIG. 9 is an illustration of an edible glue stick.

FIG. 10 shows design elements being attached to a bakery item using an edible glue stick.

### DETAILED DESCRIPTION OF THE INVENTION

### 1. EDIBLE GLUES

In one aspect, the invention features edible glues and uses thereof in adhering edible design elements (e.g. candy, edible ribbon, pastillage ornament, fondant ornament, sugar decoration, gum paste ornament, chocolate decoration, gingerbread house, Royal Icing decoration) to items (e.g., culinary items, such as a fondant covered cake, gum paste sculpture, flooded cookie, gingerbread house, croquembouche, sugar sculpture, chocolate sculpture). The invention is also useful for attaching inedible design elements (e.g., a cake base, fabric ribbons, fresh flowers, glass or plastic gemstones, cake toppers, paper decorations) to an edible culinary item (e.g. fondant covered cake, flooded cookie, gum paste sculpture, gingerbread house, croquembouche, sugar sculpture, chocolate sculpture).

In certain embodiments, the edible glue dries clear. In other embodiments, the glue may be colored and/or contain additional substances, such as an edible glitter.

In certain embodiments, the sugar glue is a thick sticky consistency, similar to refrigerated honey.

In certain embodiments, the edible glue is solid (e.g. like a candy cane) or semi-solid (e.g. like chap stick).

In certain embodiments, the edible glue dries quickly.

The edible glue may be prepared so that it is clear or one of a wide variety of clear jewel colors (e.g., red, orange, yellow, green, blue, pool blue, purple, pink, Sassie Pink, Sweet Pink, brown, lime, black, and multi-color). The edible glue may also be available in a wide variety of solid cloud colors (e.g., black, blue, green, cranberry, dark chocolate, ivory, lavender, leaf green, milk chocolate, orange, purple, red, Sassie Pink, sweet pink, turquoise, white, winter blue, yellow, and multi-color). The edible glue may also be available in a varying type to include edible glitter with a variety of colors (e.g., red, orange, yellow, green, blue, purple, pink, Sassie Pink, black, silver, gold, white iridescent, shimmer glitter, silver, and multi-color). The edible glue may also be available in varying configurations (e.g., American Cloud Collection, Christmas Collection, Extreme Glitter Collection, Halloween Collection, Harmony Collection, Valentine Collection, and Winter Collection). The edible glue may also be available in a wide variety of translucent pearl colors (e.g., black, blue, green, cranberry, dark chocolate, ivory, lavender, leaf green, milk chocolate, orange, purple, red, Sassie Pink, sweet pink, turquoise, white, winter blue, yellow, and multi-color). The edible glue may also be available in a wide variety of metallic colors (e.g., lavender metallic, pearl metallic, bronze metallic, gold metallic, yellow metallic, copper metallic, orange metallic, silver metallic, green metallic, red metallic, pink metallic, blue metallic, platinum metallic, and gun metal metallic). The edible glue may also be available in novel color combinations to include (e.g., rose quartz, natural turquoise, striated, multiple cloud, multiple jewel, or multiple pearl colors or a mix of all three). In this application, the novel color combinations may only be created by means of the edible glue gun. The edible glue stick is of a custom design for specific use with the edible glue gun described in the preceding section. Upon application the edible glue stick will not discolor after hardening.

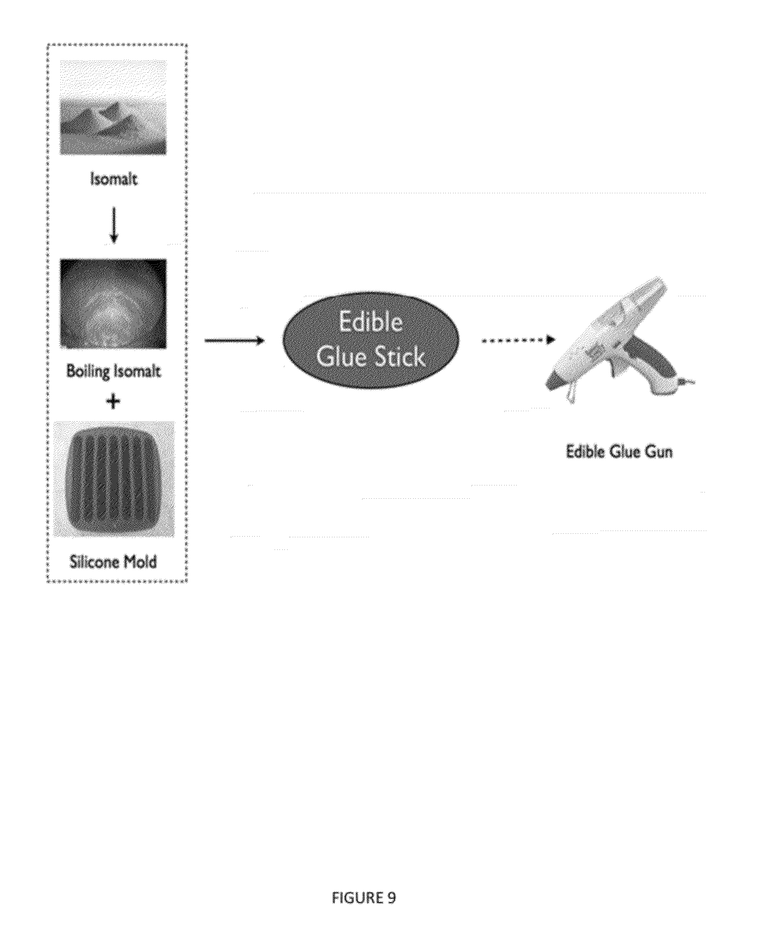

In certain embodiments, the edible glue stick is a minimum of 3.0″ length×0.5″ in diameter and no larger than 12.0″ length×1.5″ in diameter and weighs 8 ounces or less (e.g. 8.0, 7.5, 7.0, 6.5, 6.0, 5.5, 5.0, 4.5, 4.0, 3.5, 3.0, 2.5, 2.0, 1.5, 1.0, or 0.5 oz.). FIG. 9 is an illustration of an edible glue stick.

In certain embodiments, the glue is of a composition described in Tables 1, 4, 7 or 8.

### 2. APPLICATORS

The edible glues, described above, may be combined with an applicator, which is adapted for housing and delivering the particular glue formulation. An appropriate applicator will protect and house the edible glue and allow it to be readily transported and applied.

A. Glue-Stick Dispensing Apparatus

In certain embodiments, the edible glue is in a solid or semi-solid form and is housed in a container, which facilitates ejection of at least a portion of the glue. For example, the glue may be housed in and delivered from a cylindrical dispenser, which includes a threaded rod or screw that serves to turnably eject the stick of glue. The glue stick may have a central channel or circular cavity into which the threaded rod fits and in which the threaded rod turns. As the threaded rod turns, for example, by a thumbscrew or wheel, the glue becomes selectively ejected from the dispenser. Such a dispenser may have a removable cap that is used to cover the dispenser to prevent drying out of the glue. Alternatively, the dispenser may have an associated cap that remains with the dispenser, for example as described in U.S. Pat. No. 6,283,658. Although described above as a cylinder, the dispenser can be of any shape, including a square as shown, for example in U.S. Design Patent D522,696.

In certain embodiments, the dispenser is made from plastic or food grade, recyclable materials.

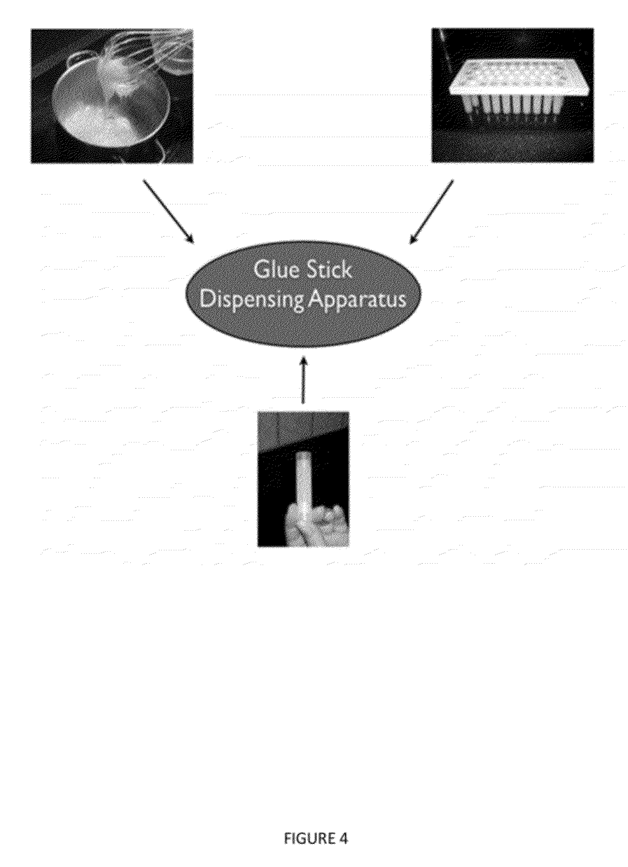

In certain embodiments, the dispensing apparatus is no larger than 4.5″ length×0.4″ in diameter and weighs 0.3 ounces or less (e.g. 0.25, 0.20, 0.15, 0.10, or 0.05 oz.). FIG. 4 is a conceptual illustration of a glue stick dispensing apparatus.

The glue stick may be applied to provide a permanent or temporary bond between a design element and an item. For example, a permanent bond may be created by rubbing a small amount of the stick to a design element and another small amount to the item onto which the design element is to be applied. The two glue spots can then be held in contact with one another for a period of time (e.g., at least about 5 seconds) to provide a permanent bond between the design element and the item. Alternatively, a small amount of the glue stick may be rubbed onto the design element and allowed to dry until it feels sticky. The sticky portion of the design element can then be contacted with the item to provide a temporary bond between the item and design element.

B. Glue Sap Dispensing Apparatus

In certain embodiments, the edible glue is a viscous, sticky fluid or sap, with a consistency similar to refrigerated honey, and is housed in a container, which may be squeezed to facilitate ejection of a portion of the glue. In certain embodiments, the squeeze bottle includes a removable cap that covers a precision applicator tip.

In certain embodiments, the dispenser is made from plastic or food grade, recyclable materials.

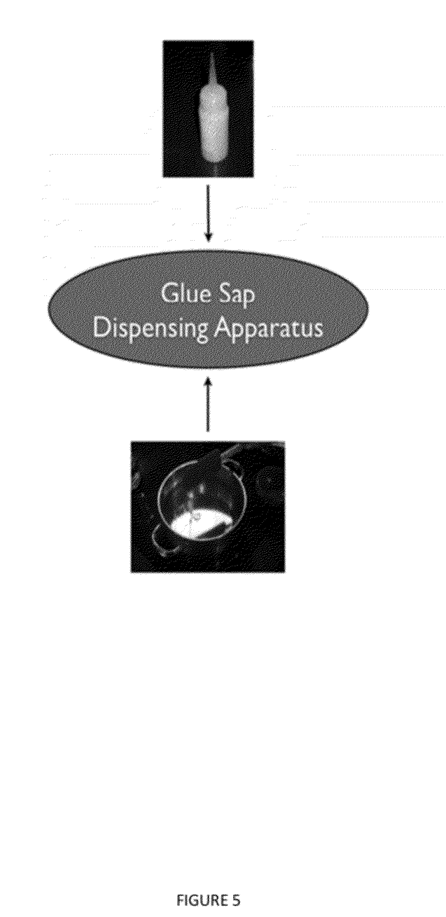

In certain embodiments, the dispensing apparatus is no larger than 6.5″ length×0.8″ in diameter and weighs 2 ounces or less (e.g. 2.0, 1.5, 1.0, or 0.5 oz.). FIG. 5 is an illustration of an edible glue sap contained in a squeeze bottle.

The glue sap may be applied to provide a permanent or temporary bond between a design element and an item. For example, a permanent bond may be created by applying a small amount of the sap to a design element and another small amount to the item onto which the design element is to be applied. The two glue spots can then be held in contact with one another for a period of time (e.g., at least about 5 seconds) to provide a permanent bond between the design element and the item. Alternatively, a small amount of the glue sap may be applied to the design element and allowed to dry until it feels sticky. The sticky portion of the design element can then be contacted with the item to provide a temporary bond between the item and design element.

C. Glue Mist Dispensing Apparatus

In certain embodiments, the edible glue mist is a thin water-like fluid and is housed in a pressurized container. Pressurization may be accomplished, for example, via an external gas or a mechanical device. Pressurization facilitates ejection of a portion of the glue mist. In certain embodiments, the glue mist dispensing apparatus (e.g., aerosol bottle) includes a removable cap that allows refill or is self-contained.

In certain embodiments, the dispenser is made from plastic or food grade, recyclable materials including metal.

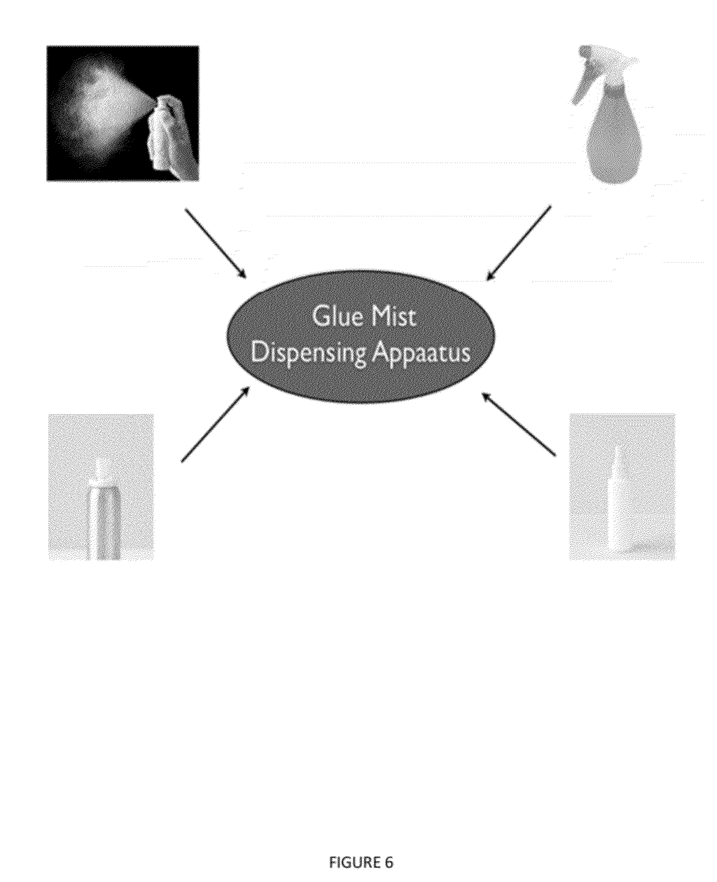

In certain embodiments, the glue mist dispensing apparatus is less than about 6.5″ in length and less than about 2.0″ in diameter. The dispensing apparatus may weigh about 10 ounces or less (e.g. 10, 9.5, 9.0, 8.5, 8.0, 7.5, 7.0, 6.5, 6.0, 5.5, 5.0, 4.5, 4.0, 3.5, 3.0, 2.5, 2.0, 1.5, 1.0, or 0.5 oz.). FIG. 6 is an illustration of an edible glue mist contained in a glue mist dispensing bottle.

The glue mist may be applied to provide a permanent or temporary bond between a design element and an item. For example, a permanent bond may be created by applying a small amount of the mist to a design element and another small amount to the item onto which the design element is to be applied. The two glue spots can then be held in contact with one another for a period of time (e.g., at least about 5 seconds) to provide a permanent bond between the design element and the item. Alternatively, a small amount of the glue mist may be applied to the design element and allowed to dry until it feels sticky. The sticky portion of the design element can then be contacted with the item to provide a temporary bond between the item and design element.

D. Quick Dry Glue Dispensing Apparatus

In certain embodiments, the edible glue is a thin, water like fluid, and is housed in a vial, with a brush attached to the vial cover that facilitates application of a portion of the quick dry glue.

In certain embodiments, the edible glue is a thin, water like fluid, and is housed in a squeeze dropper with a precision applicator tip that facilitates application of a portion of the quick dry glue.

In certain embodiments, the dispenser is made from plastic or food grade, recyclable materials including glass or metal.

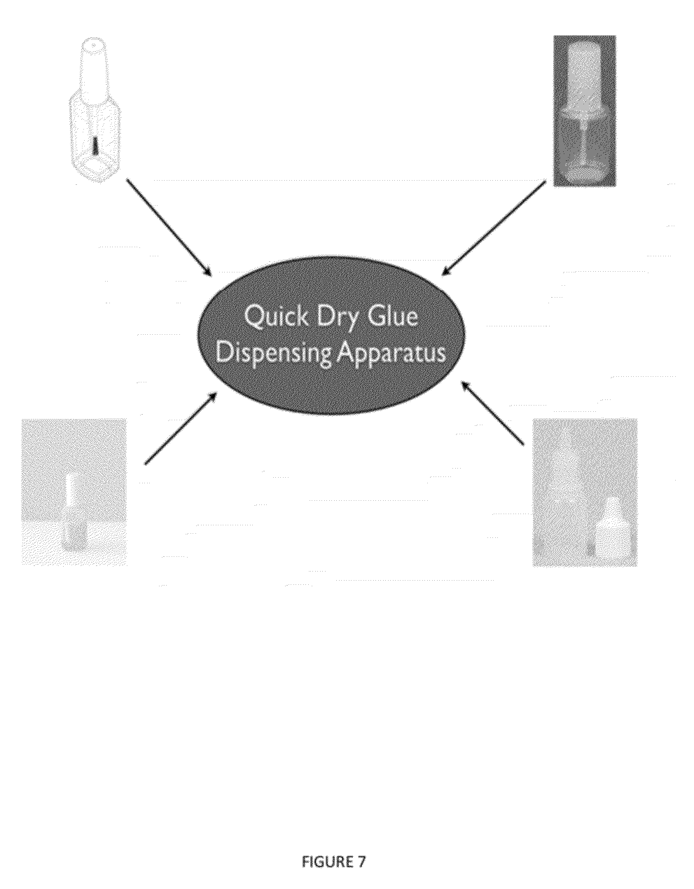

In certain embodiments, the dispensing apparatus is less than about 3.0″ in length and less than about 1.0″ in diameter. The dispensing apparatus may weigh about 3 ounces or less (e.g. 3.0, 2.5, 2.0, 1.5, 1.0, or 0.5 oz.). FIG. 7 is an illustration of an edible quick dry glue contained in a vial with a brush.

The quick dry glue may be applied to provide a permanent bond between a design element and an item. For example, a permanent bond may be created by applying a small amount of the quick dry glue to a design element and another small amount to the item onto which the design element is to be applied. The two glue spots can then be held in contact with one another for a period of time (e.g., at least about 5 seconds) to provide a permanent bond between the design element and the item.

E. Edible Glue Gun

In certain embodiments, the edible glue is in a solid or semi-solid form and is housed in a device that can heat and melt the glue to a desired consistency. For example, the device may be a gun. The gun may contain the solid or semi-solid glue in a shatterproof chamber. The gun may also include a trigger mechanism to facilitate ejection of a portion of the melted edible glue.

In certain embodiments, the gun may optionally include: (1) an indicator, showing how much glue remains in the chamber; (2) an easy load mechanism; (3) a mechanism for controlling the consistency of the melted glue; (4) a mechanism for controlling the flow of the melted glue; (5) an adjustable stand, (6) a no-drip nozzle; (7) a shatterproof enclosure; (8) a child safety lock; (9) a quick disconnect for the power cord; (10) an extended range power cord (e.g. at least about 6.0′); (11) a soft ergonomic handle; (12) a soft ergonomic trigger grip; (13) a power control; and/or (14) a status indicator.

In certain embodiments, the edible glue gun is made from plastic or metal, food grade, recyclable materials.

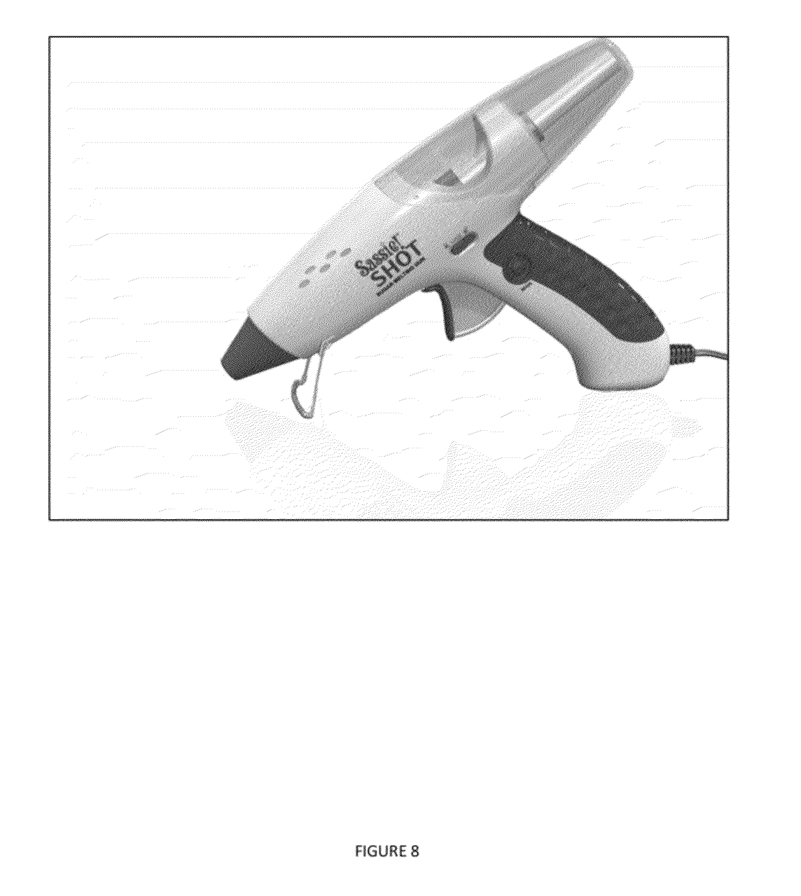

In certain embodiments, the dispensing apparatus is no larger than 11.0″ length×8.0″ height×3.0″ in diameter. FIG. 8 is a conceptual illustration of a glue gun.

The glue gun may be adjusted to provide melted edible glue of a particular consistency both a thin, runny consistency and a thick, sticky consistency dependent upon user selection. The edible glue gun provides the two forms of melted edible glue through a combination of user selectable consistency and flow control settings. The consistency is controlled through a selectable button on the edible glue gun's soft ergonomic handle. The flow rate is controlled through a tension type soft ergonomic trigger mechanism. The edible glue gun provides melted edible glue while reducing burn risk to the user by possessing an edible glue chamber which completely isolates the hot, melted edible glue. The edible glue gun edible glue chamber enables easy loading through an easy load mechanism by the user applying pressure on either side of the edible glue gun barrel to disengage the lock and glide open the loading mechanism. Once loaded with an edible glue stick, the loading mechanism is returned to its original position and a distinct click is heard when the lock is re-engaged.

The edible glue gun displays the current level, style, and color of melted edible glue present within the edible glue chamber. The edible glue gun contains an adjustable stand which allows for the edible glue gun to remain positioned upright when not in-use. The combination of a self-cleaning and self-clearing function allows for the use of different edible glue colors without user cleaning or maintenance. The edible glue gun safety prevents inadvertent use of the edible glue gun. The child safety lock is either a lock on or lock off device or disengaged by pressing forward on the safety lock and engaging the trigger; the child safety lock will snap back into a locked position and must be re-engaged each time the user picks up the edible glue gun for use. As long as the user maintains pressure on the trigger the child safety lock will not re-engage.

The edible glue gun can enable application and removal of power through a user selectable power control. The edible glue gun status indicator can inform the user of the edible glue gun status, for example, in one of six ways. A solid green indication is shown when the edible glue gun is plugged in and is in standby. When the power control button is depressed, a flashing cool blue indication is shown when the power control button is first pressed on but the device has not reached sufficient temperature. The status indicator changes from flashing cool blue to solid cool blue when the edible glue gun is powered on and has reached the user selected cool temperature which is a function of the consistency control. A flashing hot pink indication is shown when the edible glue gun transitions from cool to hot temperature but has not reached sufficient temperature. The status indicator changes from flashing hot pink to solid hot pink when the edible glue gun is powered on and has reached the user selected hot temperature which is a function of the consistency control. If the edible glue gun remains unattended for a period of time, the edible glue gun will transition from the previous state to standby (solid green indication). The status indicator is extinguished when power is removed and the edible glue gun is removed from a power source.

### 3. EXEMPLIFICATION

The invention, having been generally described, may be more readily understood by reference to the following examples, which are included merely for purposes of illustration of certain aspects and embodiments of the present invention, and are not intended to limit the invention in any way.

### EXAMPLE 1

### Edible Glue

Table 1 provides a detailed listing of ingredients used in making an edible glue in an amount appropriate to make approximately 8 sticks.

TABLE 1
Glue Stick Ingredients

| INGREDIENT | QUANTITY | |
|---|---|---|
| Cold water | 6 | Tbsp |
| Sugar syrup-composed of equal | 6 | Tbsp |
| parts sugar and water dissolved | | |
| together | | |
| Corn starch | ¼ | cup |
| Light corn syrup | 1 | Tbsp |
| White vinegar | ½ | tsp |
| Preserve-It brand potassium sorbate | ⅛ | tsp |
| mold inhibitor | | |

The above ingredients were combined as follows:

1. Mix together sugar syrup and light corn syrup in a stainless steel pot. Over medium heat, bring to a gentle boil.

2. In a separate glass bowl, make a slurry with corn starch and cold water.

3. Quickly whisk slurry into boiling mixture.

4. Add white vinegar.

5. Whisk continuously while bringing mixture back to a boil, continue whisking until smooth, thick, and translucent. Mixture will change from a liquid to a paste.

6. Remove from heat, add potassium sorbate and whisk until combined.

7. Immediately pipe mixture into applicator tubes while still warm, making sure to force out any bubbles in applicator tube.

8. Sweep off top of tube to create a smooth finish and immediately cap.

9. Store in cool, dry place—Allow to cure for one month.

After approximately one month, the edible glue solution will shrink and retract within the applicator tube and will weep moisture that should be dispelled from the applicator tube.

### EXAMPLE 2

### Environmental Testing of Edible Glue

a. Aging Test

The purpose of this test was to evaluate the edible glue stick's shelf life. The aging test simulated user storage conditions for an extended time period. The product was exposed to the following conditions:

TABLE 2
Aging Test Conditions

| TEST | | | | |
|---|---|---|---|---|
| NUMBER | DATE | TEMPERATURE | HUMIDITY | DURATION |
| TEST-002 | Jan. 30, | Room¹ | N/A | 11 Months |
| | 2011 | | | |

A single unit was stored in a kitchen cabinet at room temperature. Although humidity is defined as not applicable in Table 2, humidity was of normal humidity conditions in a climate controlled house located in the Cudjoe Key, Fla. area.

The glue stick was inspected just prior to and after the elapsed time period; no sign of degradation was present.

b. Temperature & Humidity Test

The purpose of this test was to evaluate the edible glue stick's performance under extreme operational conditions at the upper end of the temperature and humidity range. The test conditions simulated a typical event duration (for example a wedding event) where the stick may be used on a product (such as a wedding cake). The product was exposed to the following conditions:

TABLE 3
Operational Test Conditions

| TEST | | | | |
|---|---|---|---|---|
| NUMBER | DATE | TEMPERATURE | HUMIDITY | DURATION |
| TEST-001 | Aug. 26, | 91 Degrees F. | 74% | 5 Hours |
| | 2010 | | | |

These environmental conditions were produced by exposing the product to inclement weather conditions occurring on Cudjoe Key, Fla. The product itself was not exposed directly to rain, yet was placed in an unenclosed, covered patio area to allow for indirect exposure to the elements—mainly temperature and humidity conditions. The environmental conditions were as outlined in Table 3.

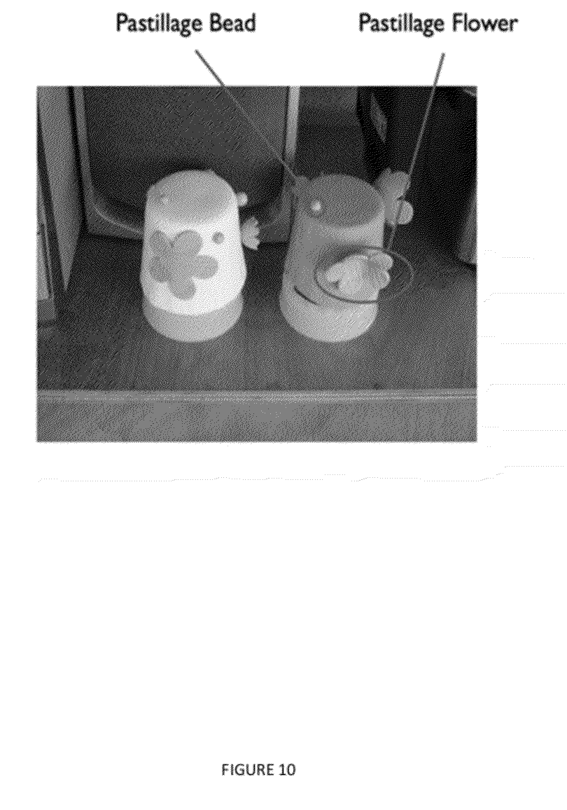

FIG. 10 shows the location of items that were attached using the edible glue stick as well as demonstration pieces. The demonstration items were fondant covered plastic cups. Pastillage-based flowers and beads were glued on to the fondant covered cup prior to the test using edible glue stick. The items were moved outdoors in the unenclosed, covered patio and placed on a flat surface as pictured in FIG. 10. The demonstration pieces were left outdoors for a period of five hours. After which time the demonstration pieces were moved indoors.

The fondant covered cups behaved in the same expected manner as a fondant covered wedding cake located in such an environment. The fondant became wet and sticky and despite several rigorous attempts to remove the pastillage-based flowers and beads without harm to the fondant covered cups, each attempt was unsuccessful. Accordingly, the test was deemed a success.

In conclusion, the demonstration of applying the edible glue stick to several fondant based decorative pieces and the subsequent failure to remove said decorative pieces from the demonstration pieces indicates that the product was used successfully in an environment at the upper limits of what it will likely experience during its operational use. No degradation in performance was observed. The edible glue stick, described above maintains its structural integrity for at least 11 months.

### EXAMPLE 3

### Edible Glue Sap

Table 4 provides a detailed listing of the ingredients used in making approximately three edible glue saps.

TABLE 4
Glue Sap Ingredients

| INGREDIENT | QUANTITY | |
|---|---|---|
| Cold water | 1 | tsp |
| Sugar syrup-1 Tbsp sugar and 1 | 2 | Tbsp |
| Tbsp water dissolved together | | |
| Light corn syrup | ¼ | cup |
| Gum tragacanth | 1 | tsp |
| Preserve-It brand potassium sorbate | ⅛ | tsp |
| mold inhibitor | | |

The above ingredients were combined as follows:

1. In a small glass dish combine sugar syrup and water. Evenly sprinkle gum tragacanth over the top of the mixture and let sit undisturbed for ten minutes.

2. Gently mix, trying to keep the gum tragacanth from clumping.

3. Meanwhile, in a stainless steel pot, gently warm light corn syrup syrup, but do not boil.

4. Remove from heat.

5. Whisk in gum tragacanth mixture. Add Preserve-It and continue whisking the mixture to thoroughly incorporate. Note: the mixture will have white bits of undissolved gum tragacanth.

6. Cover and let mixture sit overnight to dissolve the gum tragacanth as much as possible.

7. On the following day the mixture will have a solid coating of undissolved gum tragacanth bits floating on the top. Scrape off solid coating and discard.

8. Run mixture through a sieve to remove any undissolved bits of gum tragacanthVerify consistency and lack of air bubbles. The consistency should be a thick drippable liquid. When the recipe is dripped onto a counter top, a bead should form and it should not run. If the recipe is too firm, water may be whisked in in small increments until the desired consistency is reached.

9. Fill applicator bottles.

### EXAMPLE 4

### Environmental Testing of Edible Glue Sap

a. Aging Test

The purpose of this test was to evaluate the edible glue sap's shelf life. The aging test simulated user storage conditions for an extended time period. The product was exposed to the following conditions:

TABLE 5
Aging Test Conditions

| TEST | | | | |
|---|---|---|---|---|
| NUMBER | DATE | TEMPERATURE | HUMIDITY | DURATION |
| TEST-001 | Aug. 16, | Room¹ | N/A | 6 Months |
| | 2010 | | | |

A single unit was stored in an office at room temperature. Although humidity is defined as not applicable in Table 5, humidity was of normal humidity conditions in a climate controlled office located in the Boston, Mass. area.

The glue sap was inspected just prior to and after the elapsed time period; no sign of degradation was present.

b. Temperature & Humidity Test

The purpose of this test was to evaluate the edible glue sap's performance under extreme operational conditions at the upper end of the temperature and humidity range. The test conditions simulated a typical event duration (for example a wedding event) where the sap may be used on a product (such as a wedding cake). The product was exposed to the following conditions:

TABLE 6
Operational Test Conditions

| TEST | | | | |
|---|---|---|---|---|
| NUMBER | DATE | TEMPERATURE | HUMIDITY | DURATION |
| TEST-002 | Aug. 26, | 91 Degrees F. | 74% | 5 Hours |
| | 2010 | | | |

These environmental conditions were produced by exposing the product to inclement weather conditions occurring in the Cudjoe Key, Fla. area. The product itself was not exposed directly to rain, yet was placed in an unenclosed, covered patio area to allow for indirect exposure to the elements—mainly temperature and humidity conditions. The environmental conditions were as outlined in Table 6 and are expected to be the upper limits of what the edible sap is expected to be of effective use.

FIG. 10 shows the location of items that were attached using the edible glue sap as well as demonstration pieces. The demonstration items were fondant covered plastic cups. Pastillage-based flowers and beads were glued on to the fondant covered cup prior to the test using the edible glue sap. The items were moved outdoors in the unenclosed, covered patio and placed on a flat surface as pictured in FIG. 10. The demonstration pieces were left outdoors for a period of five hours. After which time the demonstration pieces were moved indoors.

The fondant covered cups behaved in the same expected manner as a fondant covered wedding cake located in such an environment. The fondant became wet and sticky and despite several rigorous attempts to remove the pastillage-based flowers and beads without harm to the fondant covered cups, each attempt was unsuccessful. Accordingly, the test was deemed a success.

In conclusion, the demonstration of applying the edible glue sap to several fondant based decorative pieces and the subsequent failure to remove said decorative pieces from the demonstration pieces indicates that the product was used successfully in an environment at the upper limits of what it will likely experience during its operational use. No degradation in performance was observed.

### EXAMPLE 5

### Edible Glue Stick

Table 7 provides a detailed listing of the ingredients used in making approximately forty-eight edible glue sticks.

TABLE 7
Edible Glue Stick (48 Units)

| Item | | | | |
|---|---|---|---|---|
| Number | Item | Quantity | | Description |
| 1 | Isomalt | 3 | lb. | |
| 2 | Distilled | ¾ | Cup | May not be a ¾ cup exactly; just need |
| | Water | | | to add enough to make Isomalt the |
| | | | | consistency of wet sand. |

The edible glue sticks are composed of two core ingredients—Isomalt (or sugar) and water. In addition, various colors (transparent, non-transparent, and translucent), edible glitter, flavor and scent may be added to the core ingredients depending upon the desired style, as shown in Table 8.

TABLE 8
Edible Glitter Glue Stick (48 Units)

| Item | | | | |
|---|---|---|---|---|
| Number | Item | Quantity | | Description |
| 1 | Isomalt | 3 | lb. | |
| 2 | Distilled Water | ¾ | Cup | May not be a ¾ cup exactly; |
| | | | | just need to add enough to make |
| | | | | Isomalt the consistency of wet |
| | | | | sand. |
| 3 | Flavoring | ¼ | tsp | Flavoring may be purchased |
| | (And/Or) | | | from CK products. |
| | Scent | ¼ | tsp | Scent may be purchased from |
| | (And/Or) | | | CK products. |
| | Edible Glitter | 15 | Grams | Disco Dust by Sunflower |
| | (And/Or) | | | Sugar Art. |
| | Food Coloring | ¼ | tsp | Food coloring is of soft gel type |
| | | | | purchased from CK Products. |

The above ingredients may be combined as follows:

1. Start with a clean stainless steel pot and stainless steel utensils.
2. Place 3 pounds (lbs.) of Isomalt in the stainless steel pot.
3. Add enough distilled water to make the Isomalt look like wet sand (approximately six ounces).
4. Turn the burner to high heat.
5. Stir to help the crystalline Isomalt melt and turn into a liquid.
6. When Isomalt mixture comes to a boil, insert a candy thermometer.
7. Leave the mixture untouched without stirring until it reaches 310 degrees Fahrenheit.
8. Remove pot from heat.
9. Add color, glitter, scent, or flavor as desired.
10. Slowly pour the hot Isomalt into silicone stick molds and allow to cool 1.5 hours until firm.

The above procedure can be performed to make sticks that contain edible glitter, are colored, flavored, scented or a combination of any of the preceding. The coloring may be shallowly stirred on top of Isomalt until it stops bubbling. This will allow the moisture to evaporate. Once the bubbling stops, the color may be mixed throughout the entire pot. If glitter is desired cool the Isomalt to 285 degrees. Sprinkle glitter evenly across the top of all the Isomalt and whisk gently to combine. The scent and flavoring can be added in the same manner as the coloring.

### 4. INCORPORATION BY REFERENCE

The contents of all cited references including literature references, issued patents, published or non-published patent applications as cited throughout this application are hereby expressly incorporated by reference.

### 5. EQUIVALENTS

Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed.

1. An apparatus comprising a semi-solid edible glue housed in a container, which facilitates ejection of at least a portion of the glue.

2. An apparatus of claim 1, wherein the container is cylindrical.

3. An apparatus of claim 1, wherein the container includes a threaded rod or screw that serves to turnably eject the glue.

4. An apparatus of claim 1, wherein the container includes a removable cap.

5. An apparatus of claim 1, wherein the container is no larger than 4.5″×0.4.

6. An apparatus of claim 1, which weighs 0.3 ounces or less.

7. An apparatus of claim 1, wherein the edible glue dries clear.

8. An apparatus of claim 1, wherein the edible glue is colored, contains a glitter, is flavored, or scented.

9. An apparatus comprising a viscous, sticky edible glue housed in a container.

10. An apparatus of claim 9, wherein the container is a squeeze bottle.

11. An apparatus of claim 9, wherein the container includes a removable cap.

12. An apparatus of claim 9, wherein the container may include a precision tip applicator.

13. An apparatus of claim 9, wherein the container is no larger than 6.5″×0.8″.

14. An apparatus of claim 9, wherein the container weighs 2 ounces or less.

15. An apparatus of claim 9, wherein the edible glue is colored, contains a glitter, is flavored, or scented.

16. An apparatus comprising a solid, edible glue housed in a device that can heat and melt the glue to a desired consistency.

17. An apparatus of claim 16, wherein the device is a gun.

18. An apparatus of claim 16, wherein the device includes a shatterproof enclosure for housing the solid, edible glue.

19. An apparatus of claim 16, wherein the device includes a trigger mechanism to facilitate ejection of at least a portion of the melted, edible glue.

20. An apparatus of claim 16, wherein the edible glue is colored, contains a glitter, flavor, or scent.
